(19) United States
(12) Patent Application Publication
(10) Pub. No.: US 2005/0229994 A1
(43) Pub. Date: Oct. 20, 2005

(54) Busway lighting systems

(76) Inventor: Jari Turkia, Duluth, GA (US)

Correspondence Address: Russell A. Korn;SUTHERLAND ASBILL & BRENNAN LLP, 999 Peachtree Street, NE, Atlanta, GA, 30309-3996, US

(21) Appl. No.: 10/955,877

(22) Filed: Sep. 30, 2004

Related U.S. Application Data
(60) Provisional application No. 60/521,386, filed on Apr. 15, 2004.

(51) Int. Cl. H01R 4/60

(52) U.S. Cl. 139/110

(57) ABSTRACT

A busway lighting system including, a first conductor, a second conductor laterally opposing the first conductor. The first conductor and second conductor are retained in a busway lighting section and carry currents of greater than twenty amps. The busway lighting section may further include a top surface and at least two lateral surfaces. The first and second conductors may be retained on the at least two lateral surfaces and may be affixed to channels in respective lateral surfaces.

### RELATED APPLICATION DATA

The present application claims benefit of U.S. Provisional Application No. 60/521,386, entitled “Busway Lighting System,” filed on Apr. 15, 2004.

### TECHNICAL FIELD

The present invention relates generally to the field of lighting and more particularly relates to busway lighting systems.

### BACKGROUND OF THE INVENTION

Traditionally track lighting has been the predominant means of providing flexible lighting that allows luminaries to be moved (along the track section) as desired. Busway is an alternative means for providing flexible lighting, although through higher current electrical conductors. Track lighting is a low current system of 20 amps or less that is regulated by restrictions specifying a minimum load per track length. For building approval purposes, the energy consumption of a track lighting system is determined based on regulation specified load, not actual connected load. Since actual connected load is often less than code specified load, track is effectively penalized from an energy standpoint. These regulations severely restrict the useability and effectiveness of track lighting, particularly in energy conscious States such as California. Busway systems, on the other hand, use currents greater than 20 amps. Busway systems do not have regulations specifying a minimum load per foot, but rather are rated on their actual connected load. Today's busway systems are large, often multi-circuit products, containing a voltage conductor together with a neutral conductor on a common plane in their single-circuit formats. Due to the common plane conductors, current busway systems lack the low-profile design desired in certain applications. The existing busway systems also utilize either snap-in or lever-locking type plug boxes to access the conductors of the busway section. These configurations limit the functionality of busway systems in retail stores where a low profile installation is preferred and lights are moved on a regular basis because the plug boxes cannot be easily inserted, removed, or moved. Thus, there is a need in the art for simple busway systems that accommodate easily removable plug boxes that are used to efficiently add, remove lights, or move lights on the busway system.

### SUMMARY OF THE INVENTION

The present invention provides a busway lighting system including, a first conductor, a second conductor laterally opposing the first conductor. The first conductor and second conductor are retained in a busway lighting section and carry currents of greater than twenty amps. In another aspect of the invention, the busway lighting section may further include a top surface and at least two lateral surfaces. The first and second conductors may be retained on the at least two lateral surfaces and may be affixed to channels in respective lateral surfaces. The channels may have a substantially T-shaped cross-section. The conductors may extend substantially the length of the busway lighting section and may further reside in insulation.

The busway lighting section may provide a ground for the busyway lighting system. Further, the busway lighting section may include a bottom longitudinal surface. The bottom longitudinal surface may include an opening which may be off-center.

A plug box may interface the busway lighting section. The plug box may include a first contact and a second contact. The first and second contacts may be configured on opposing sides of the plug box so as to interface the first conductor and second conductor of the busway section, respectively, when the plug box interfaces the busway lighting section.

The present invention may also include a method of interfacing a plug box with a busway lighting system. The method may include the steps of providing a busway lighting section, wherein the section includes at least two laterally opposed surfaces defining a chamber wherein the laterally opposed surfaces include a first conductor and second conductor; providing a plug box, wherein the plug box includes a contact head and a first contact and second contact on opposite sides of the contact head; and interfacing the plug box and busway lighting section so the first and second conductors of the busway lighting section engage the first and second contacts of the plug box, respectively.

### BRIEF DESCRIPTION OF THE DRAWINGS

FIG. 1 is a cross-sectional view of a busway lighting section.

FIG. 2 is a cross-sectional view of a plugbox for use in a busway lighting section.

FIG. 3 is a perspective view of a busway lighting section.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

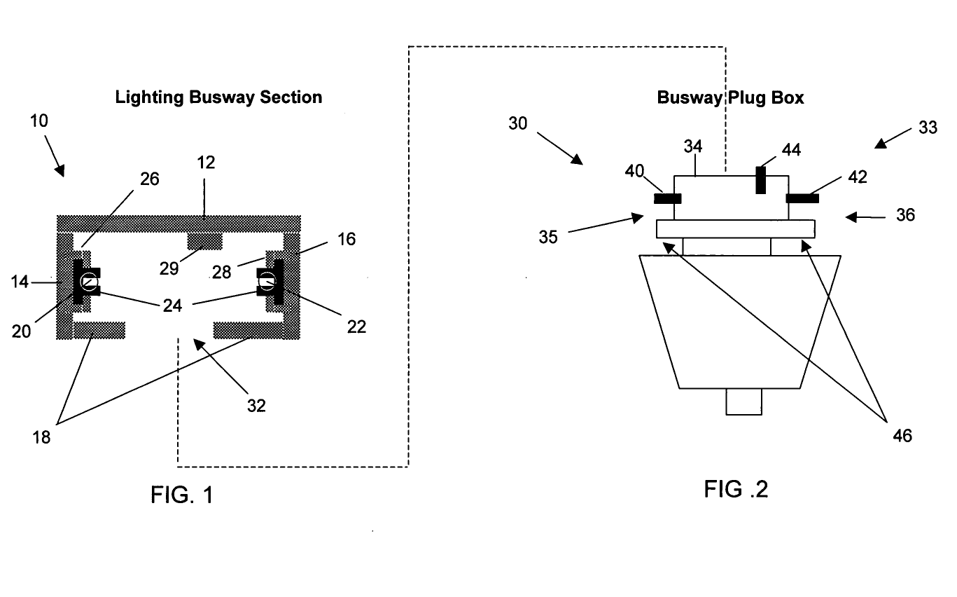

FIG. 1 illustrates an embodiment of the busway lighting section 10. The busway lighting section includes a first conductor 20 that laterally opposes a second conductor 22. The first conductor 20 may be a neutral conductor, and the second conductor 22 may be a voltage-line conductor. Connecting a plug box to the first conductor 20 and the second conductor 22 closes the circuit creating voltage potential and allowing current flow between the conductors.

The conductors being laterally opposed allows for twist-in or other types of plug boxes to easily access the conductors of the busway lighting system. The first and second conductors 20, 22 are of a sufficient thicknesses to enable current flow greater than 20-Amps. In an exemplary embodiment, the conductors include ten-gauge wires. One of ordinary skill in the art would appreciate that any gauge wire that accommodates current flow of greater than 20-Amps is contemplated. The conductors may comprise single strand wires, twisted strands of wires, or any other wire configuration capable of accommodating electrical current flow. The conductors may be made of any suitable material such as copper or aluminum.

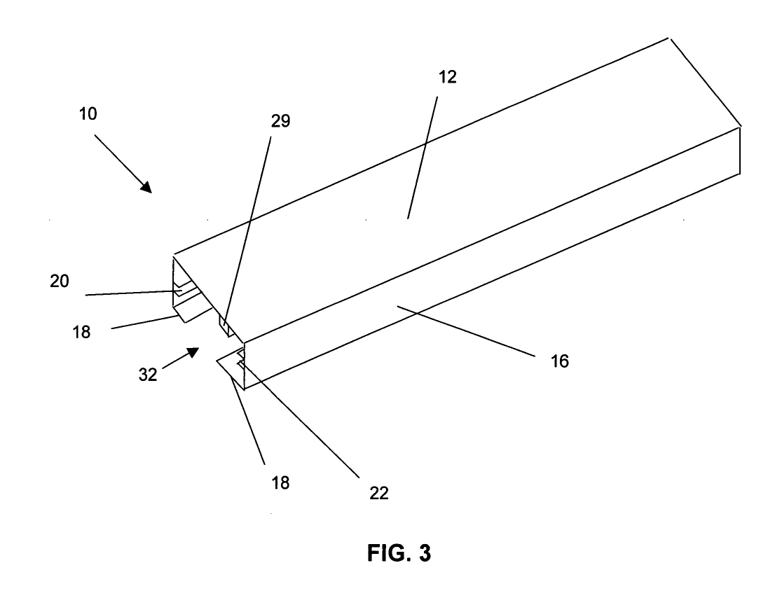

The conductors 20, 22 may be retained in any shaped structure that allows the conductors to be laterally opposed. For example, the busway lighting section may include a structure of a rectangular shape, triangular shape, or any other suitable shaped structure. In the exemplary embodiment illustrated in FIGS. 1 and 3, a longitudinal busway section 10 includes a first end and a second end. The busway section 10 may include a top longitudinal surface 12, a first lateral surface 14, and a second lateral surface 16. The busway section 10 may further include a bottom longitudinal surface 18. The first lateral surface 14 includes a first conductor 20 and the second lateral surface 16 includes a second conductor 22.

The first and second conductors 20, 22 may be incorporated into insulating sleeves 24 to insulate the first and second conductors 20, 22 from the first and second lateral surfaces 14, 16, respectively. One of ordinary skill in the art would appreciate that the insulating sleeves may be made of any non-conductive material such as rubber, plastics, ceramics, or any other suitable material.

In an exemplary embodiment, the conductors 20,22 are affixed to the lateral surfaces by residing in a first channel 26 of the first lateral surface 14 and a second channel 28 of the second lateral surface 16. As shown in the illustrative example of FIG. 1, the first and second channels in an exemplary embodiment have a substantially T-shaped cross-section. One of ordinary skill in the art would appreciate that the first channel and second channel are not limited to cross-sections having a substantial T-shape but may be L-shaped, H-shaped, squarely shaped, circularly shaped or have any other cross-section that allows the conductors 20, 22 to be affixed thereto.

The top longitudinal surface 12 may support the first lateral surface 14 and the second lateral surface 16 such that the first lateral surface laterally opposes the second lateral surface. The top longitudinal surface 12 also may be used to ground the busway section 10. A substantially vertical protrusion 29 from the top longitudinal surface 12 may project downward to provide a ground location. However, the top longitudinal surface does not have to provide a ground for busway section. One of ordinary skill in the art would appreciate that a ground could be provided on any surface of the busway section or a separate ground wire.

The bottom longitudinal surface 18 of the busway section 10 may provide support for a plug box 30, as illustrated in FIG. 2, that interfaces with the busway section 10. The bottom longitudinal surface 18 includes an opening 32 to allow portions of the plug box 30 to be inserted into the busway section 10, to allow portions of the plug box 30 to reside above the bottom longitudinal surface 18 of the busway section 10, and/or to provide support to the plug box 30 while attached to the busway section 10. In an exemplary embodiment, the bottom longitudinal section 18 may include a slightly off center opening to create asymmetric mechanical support surfaces for the plug box 30. If ample support may be provided to a plug box 30 from the top longitudinal surface 12, first lateral surface 14, or second lateral surface 16, the bottom longitudinal surface 18 may not be required.

With reference to FIG. 2, illustrated is a busway plug box 30 that may interface the busway section 10. The plug box 30 may interface the first conductor 20, second conductor 22, and ground 29 of the busway system to create an electrical circuit for illuminating light bulbs or other lighting apparatus connected to plug box 30. As discussed previously, the ground may not be a surface of the busway system but a separate ground wire. The plug box 30 includes a contact head 33 having a top longitudinal side 34, a first lateral side 35, and a second lateral side 36.

The contact head 33 further includes a first contact 40 on the first lateral side 35 of the contact head 33 and a second contact 42 on the second lateral side 36 of the contact head 33. The first contact 40 may be a neutral contact, and the second contact 42 may be a voltage-line contact.

The first contact 40 and the second contact 42 are positioned such that the contacts align with the first and second conductors 20, 22 of the busway section 10 when the plug box 30 is interfaced with the busway section 10. The plug box 30 also may include a ground contact 44. The ground contact may be located on the top longitudinal surface 34 of the contact head 33 if the ground from the busway section is located on top longitudinal surface 12. The ground contact 44 may be positioned to align with the ground protrusion 29 of the busway section 10 when the plug box 30 is interfaced with the busway section 10. Alternatively, the ground protrusion 29 and ground contact 44 may take forms other than that illustrated and/or be relocated to another surface of their respective structures and achieve the same mating relationship.

The contact head 33 also may include asymmetric mechanical support tabs 46 located at opposing lateral sides of the contact head 33 below the first and second contacts 40, 42. The support tabs 46 may rest on the bottom longitudinal surface 18 of the busway section 10 for mechanical support when the contact head 33 is interfaced with the busway section 10. However, alternative structures may be utilized to achieve a desired degree of structural stability.

In an exemplary embodiment, the busway plug box 30 may be connected to the busway section 10 by insertion of its contact head 33 into the opening 32 on the bottom longitudinal surface 18 of the busway section with the first and second contacts 40, 42 and asymmetric support tabs 46 of the busway plug box in a perpendicular orientation to the first and second lateral sides 14, 16 of the busway section 10. The busway plug box 30 may be rotated approximately 90-degrees and mechanically locked into position in the busway section 10 causing the first and second contacts 40, 42 of the plug box 30 to create an electrical connection with the first and second conductors 20, 22 of the busway section. The support tabs 46 of the busway plug box 30 may be asymmetrical to correspond with the asymmetric mechanical support surfaces of the busway section 10, ensuring that the plug box 30 can only be fully rotated and engaged in one direction, guaranteeing correct polarity. However, one of ordinary skill in the art will appreciate that the plug box may be inserted into the busway section in any manner that allows the lateral conductors of the contact head to interface the lateral conductors of the busway section such that adequate support is provided to the plug box by the busway section.

It should be apparent that the foregoing relates only to the preferred embodiments of the present invention and that numerous changes and modifications may be made herein without departing from the spirit and scope of the invention as defined by the following claims.

1. A busway lighting system comprising:
a first conductor;
a second conductor laterally opposing the first conductor, wherein the first conductor and second conductor are retained in a busway lighting section and carry currents of greater than twenty amps.

2. The system of claim 1, wherein the busway lighting section further comprises one top surface and at least two lateral surfaces.

3. The system of claim 2, wherein the first and second conductors are retained on the at least two lateral surfaces.

4. The system of claim 3, wherein the first and second conductors are affixed to channels in respective lateral surfaces.

5. The system of claim 4, wherein the channels have a substantially T-shaped cross-section.

6. The system of claim 1, wherein the first and second conductors extend substantially the length of the busway lighting section.

7. The system of claim 1, wherein the first and second conductors reside in insulation.

8. The system of claim 2, wherein the busway lighting section comprises a ground for the busway lighting system.

9. The system of claim 1, wherein the busway lighting section further comprises a bottom longitudinal surface.

10. The system of claim 9, wherein the bottom longitudinal surface includes a longitudinal opening.

11. The system of claim 10, wherein the longitudinal opening is off center of the bottom longitudinal surface.

12. The system of claim 1 further comprising a plug box wherein the plug box interfaces the busway lighting section.

13. The system of claim 12, wherein the plug box comprises a first contact and a second contact, wherein the first and second contacts are configured on opposing sides of the plug box so as to interface the first conductor and second conductor of the busway section, respectively, when the plug box interfaces the busway lighting section.

14. A busway lighting section comprising:
a longitudinal top surface;
a first lateral surface extending from the longitudinal top surface;
a second lateral surface extending from the longitudinal top surface, wherein the second lateral surface laterally opposes the first lateral surface;
a first conductor affixed to the first lateral surface;
a second conductor affixed to the second lateral surface, wherein the first conductor laterally opposes the second conductor,
wherein the first and second conductor are configured to carry currents of greater than twenty amps.

15. A method of interfacing a plug box with a busway lighting system comprising the steps of:
providing a busway lighting section, wherein the section includes at least two laterally opposed surfaces defining a chamber wherein the laterally opposed surfaces include a first conductor and second conductor;
providing a plug box, wherein the plug box includes a contact head and a first contact and second contact on opposite sides of the contact head; and
interfacing the plug box and busway lighting section so the first and second conductors of the busway lighting section engage the first and second contacts of the plug box, respectively.
